(19) United States
(12) Patent Application Publication
(10) Pub. No.: US 2026/0287459 A1
(43) Pub. Date: Sep. 24, 2026

(54) DETECTION DEVICE

(71) Applicant: DENSO CORPORATION, Kariya-city (JP)

(72) Inventors: Toshiro NISHIMURA, Kariya-city (JP); Kazuya NAGATA, Kariya-city (JP)

(21) Appl. No.: 19/443,751

(22) Filed: Jan. 8, 2026

Related U.S. Application Data
(63) Continuation of application No. PCT/JP2024/024783, filed on Jul. 9, 2024.

(30) Foreign Application Priority Data
Jul. 13, 2023 (JP) 2023-115273
Apr. 19, 2024 (JP) 2024-067952

(51) Int. Cl. G01M 3/16; B60R 16/023; B62D 5/04

(52) U.S. Cl. CPC G01M 3/16; B62D 5/046; B62D 5/0481; B60R 16/0232

(57) ABSTRACT

A detection device includes a sensor unit, a communication circuit and a control unit. The sensor unit includes a resistor or a capacitor connected to a first conductor and a second conductor provided on a sensor substrate, and is provided in an area that is subject to water intrusion. The communication circuit outputs a water intrusion detection signal to the first conductor, and receives the water intrusion detection signal from the second conductor via the resistor or the capacitor. The communication circuit and the control unit are provided at positions different from the sensor unit. The water intrusion detection unit determines that the sensor unit is subject to water intrusion when receiving the water intrusion detection signal is a signal having a pattern that is different from a normal pattern.

### CROSS REFERENCE TO RELATED APPLICATION

The present application is a continuation application of International Patent Application No. PCT/JP2024/024783 filed on Jul. 9, 2024, which designated the U.S. and claims the benefit of priority from Japanese Patent Application No. 2023-115273 filed on Jul. 13, 2023, and Japanese Patent Application No. 2024-067952 filed on Apr. 19, 2024. The entire disclosures of all of the above applications are incorporated herein by reference.

### TECHNICAL FIELD

The present disclosure relates to a detection device.

### BACKGROUND

Conventionally, an electric power steering device in which an assist mechanism is provided on a rack shaft is known. In this case, a pair of electrodes is used as a water detector. When the pair of electrodes are submerged in water, electrical conduction occurs through the water, thereby detecting the water intrusion.

### SUMMARY

According to an aspect of the present disclosure, a detection device includes: a sensor unit including a resistor or a capacitor connected to a first conductor and a second conductor that are provided on a sensor substrate, the sensor unit being provided in an area that is subject to water intrusion; a communication circuit configured to output a water intrusion detection signal to the first conductor and to receive the water intrusion detection signal from the second conductor via the resistor or the capacitor; and a controller including at least one of a circuit and a processor having a memory storing computer program code. The communication circuit and the controller are provided at positions different from the sensor unit. In the detection device, the controller is configured to determine whether the water intrusion detection signal received at the communication circuit has a signal pattern different from a normal pattern, and to determine that the sensor unit is subject to water intrusion when the water intrusion detection signal received at the communication circuit has a signal pattern that is different from the normal pattern.

### BRIEF DESCRIPTION OF THE DRAWINGS

The above and other features of the present disclosure will become more apparent from the following detailed description made with reference to the accompanying drawings. In the drawings:

FIG. 1 is a schematic diagram showing a steering system according to a first embodiment of the present disclosure;

FIG. 2 is a cross-sectional view showing an electric power steering device according to the first embodiment;

FIG. 3 is a schematic diagram showing a detection device according to the first embodiment;

FIG. 4 is a block diagram showing the detection device according to the first embodiment;

FIG. 5 is a time chart showing water intrusion detection according to the first embodiment;

FIG. 6 is a flowchart showing a water intrusion detection process according to the first embodiment;

FIG. 7 is a schematic diagram showing a detection device according to a second embodiment of the present disclosure; and

FIG. 8 is a block diagram showing a detection device according to the second embodiment.

### DETAILED DESCRIPTION

For example, a pair of electrodes may be used as a water intrusion detector. In this case, when the pair of electrodes are submerged in water, electrical conduction occurs through the water, thereby detecting water intrusion. However, in the water intrusion detector, it is necessary to add logic for detecting water intrusion, such as applying a voltage to the electrodes from a control unit and detecting the voltage.

It is an object of the present disclosure to provide a detection device that can appropriately detect water intrusion with a simple structure.

A detection device according to an exemplar of the present disclosure includes a sensor unit, a communication circuit, and a control unit. The sensor unit includes a resistor or a capacitor connected to a first conductor and a second conductor that are provided on a sensor substrate, and is provided in an area that is subject to water intrusion. The communication circuit is configured to output a water intrusion detection signal to the first conductor and to receive the water intrusion detection signal from the second conductor via the resistor or the capacitor. The control unit includes a water intrusion detection unit that is configured to detect water intrusion of the sensor unit based on the water intrusion detection signal.

The communication circuit and the control unit are provided at positions different from the sensor unit. In addition, the water intrusion detection unit is configured to determine that the sensor unit is subject to water intrusion when the water intrusion detection signal received at the communication circuit has a signal pattern that is different from a normal pattern. In such manner, a proper detection of water intrusion is made possible with a simple structure.

### First Embodiment

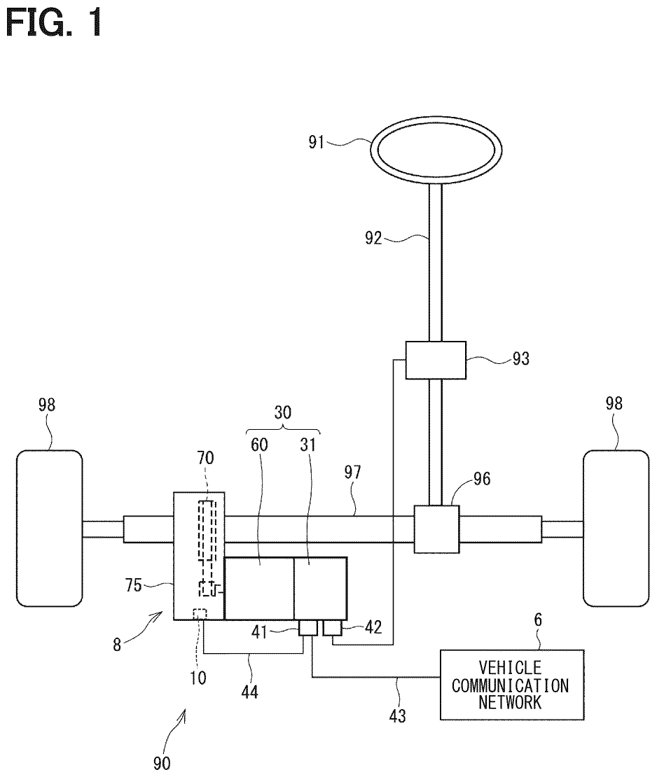

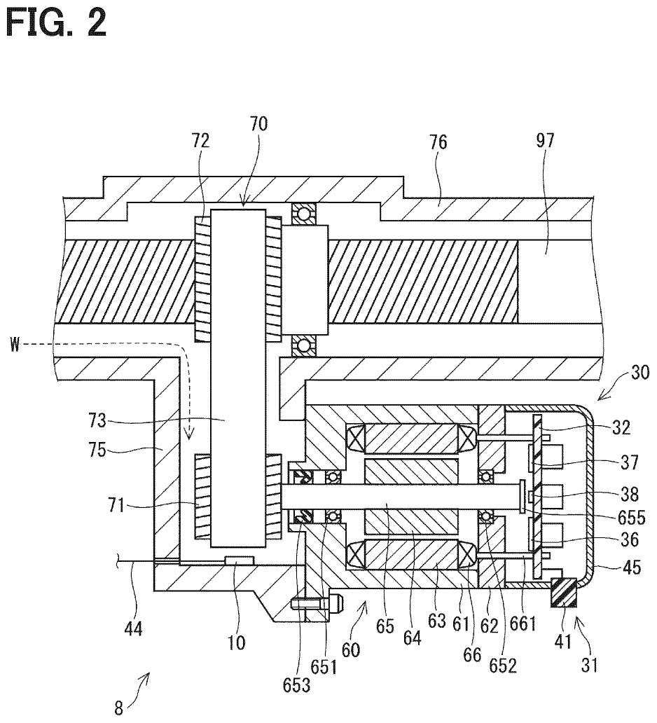

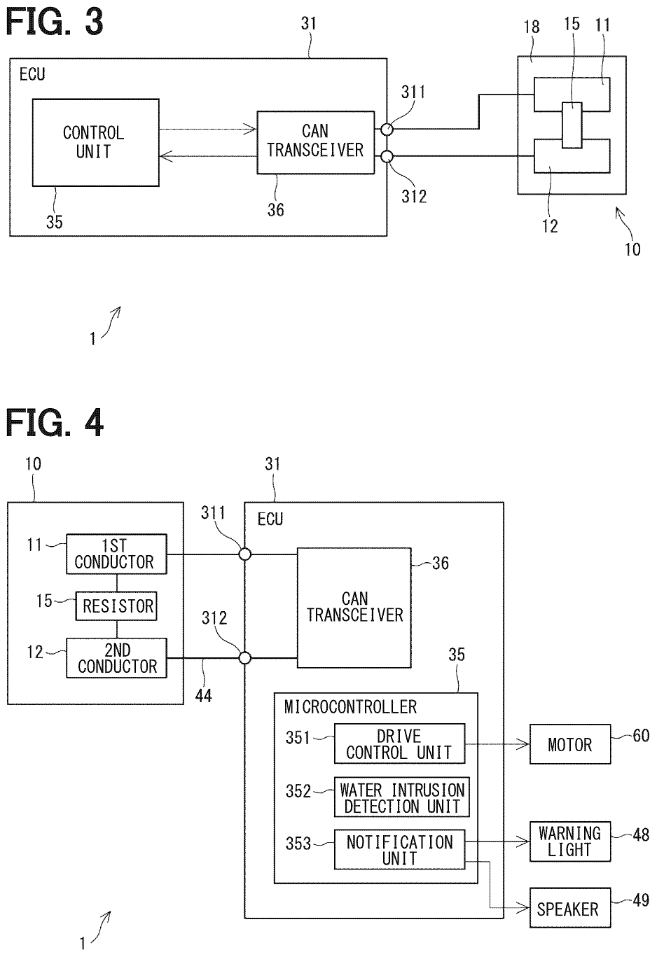

Hereinafter, a detection device according to the present disclosure will be explained based on the drawings. In the following plural embodiments, substantially same structural configurations are designated with the same reference numerals thereby to simplify the description. A detection device according to the first embodiment is shown in FIGS. 1 to 6. As shown in FIGS. 3 and 4, a detection device 1 includes a sensor unit 10, a CAN transceiver 36, and a control unit 35, and is applied to an electric power steering device 8, which is a steering device for assisting the steering operation of a vehicle (see FIG. 2).

FIG. 1 shows an overall configuration of a steering system 90 including the electric power steering device 8. The steering system 90 includes a steering wheel 91 which is a steering member, a steering shaft 92, a pinion gear 96, a rack shaft 97, road wheels 98, the electric power steering device 8 and the like.

The steering wheel 91 is connected to the steering shaft 92. A torque sensor 93 is provided on the steering shaft 92 to detect a steering torque. The pinion gear 96 is provided at an axial end of the steering shaft 92. The pinion gear 96 engages with the rack shaft 97. A pair of road wheels 98 is coupled to both ends of the rack shaft 97 via, for example, tie rods. Various parts related to the transmission of steering and provided on the path from the steering wheel 91 to the road wheels 98 are referred to as steering transmission parts. The steering transmission parts include the steering shaft 92, the pinion gear 96, the rack shaft 97, and the like.

When a driver of the vehicle rotates the steering wheel 91, the steering shaft 92 connected to the steering wheel 91 rotates. A rotational movement of the steering shaft 92 is converted to a linear movement of the rack shaft 97 by the pinion gear 96. The pair of road wheels 98 is steered to an angle corresponding to a displacement amount of the rack shaft 97.

The electric power steering device 8 includes a drive device 30 having an ECU 31 and a motor 60, a speed reduction mechanism 70 as a power transmission unit that reduces the rotation of the motor 60 and transmits it to the rack shaft 97, and the like. The electric power steering device 8 of the present embodiment is a so-called “rack assist type,” but may also be a so-called “column assist type” in which the rotation of the motor 60 is transmitted to the steering shaft 92, or the like. The drive device 30 is attached to a vertically lower side of the rack shaft 97.

The ECU 31 is provided with connectors 41 and 42. The connector 41 is provided to be connectable to a vehicle communication network 6, the sensor unit 10, and a vehicle power supply (not shown). In the present embodiment, the vehicle communication network 6 and the sensor unit 10 are connected by CAN (Controller Area Network) wiring 43 and 44, which are signal wiring. The connector 42 is connected to the torque sensor 93. In the present embodiment, the connector 41 is an integrated hybrid connector in which a communication system connector and a power system connector are integrated, but the openings for the communication system and the power system may be separated. The number and orientation of the connector openings can be designed as appropriate.

The motor 60 is a three-phase brushless motor. The motor 60 outputs a part or all of the torque required for steering, and is driven by electric power supplied from the vehicle power supply to rotate the speed reduction mechanism 70 forward and reverse. The speed reduction mechanism 70 is housed in a gear housing 75.

As shown in FIG. 2, the drive device 30 is a so-called “mechanically integrated” type in which the ECU 31 is integrally provided on one side of the motor 60 in the axial direction. However, the drive device 30 may be not a mechanically integrated type, and the motor 60 and the ECU 31 may be provided separately.

The ECU 31 includes an ECU board 32, the connectors 41 and 42, an ECU cover 45, and the like. The ECU board 32 is mounted with various electronic components such as a microcontroller that constitutes the control unit 35, a CAN transceiver 36 (see FIG. 3), a switching element 37 that switches a flow of electric current through motor wires 66, and a rotation angle sensor 38.

The connectors 41 and 42 are connected to the ECU board 32 by connector terminals. The openings of the connectors 41 and 42 are provided on the outside of the ECU cover 45 so that the harnesses can be inserted and removed. The ECU cover 45 is formed in a generally cylindrical shape with a bottom, and houses the ECU board 32 therein. The connectors 41 and 42 and the ECU cover 45 may be integrally formed.

The motor 60 includes a motor case 61, a motor frame 62, a stator 63, a rotor 64, a shaft 65, and the motor wires 66. The motor case 61 is formed in a cylindrical shape with a bottom that opens toward the ECU 31, and the stator 63 is fixed on a radial inside thereof. The motor frame 62 is provided on an opening side of the motor case 61.

The rotor 64 is provided radially inside the stator 63, and is rotatable relative to the stator 63. The shaft 65 is fitted into the rotor 64 and rotates integrally with the rotor 64. The shaft 65 is rotatably supported by the motor case 61 and the motor frame 62 via bearings 651 and 652. A waterproof rubber 653 is provided on a small diameter pulley 71 side of the bearing 651 to separate an inner space of the gear housing 75 from an inner space of the motor 60. An end of the shaft 65 on an ECU 31 side is exposed from the motor frame 62 toward the ECU board 32, and a sensor magnet 655 is provided thereon. The rotation angle sensor 38 is provided at a position facing the sensor magnet 655.

The motor wires 66 are wound around a stator 63. Lead wires 661 are taken out from respective phases of the motor wires 66 and connected to the ECU board 32. By controlling the flow of electric current to the motor wires 66, a rotating magnetic field is generated in the stator 63. The rotor 64 is provided with a magnet on a radial outside thereof, and rotates integrally with the shaft 65 due to the rotating magnetic field formed in the stator 63.

The speed reduction mechanism 70 includes a small diameter pulley 71, a large diameter pulley 72, and a belt 73. The small diameter pulley 71 is provided at one end of the shaft 65 opposite to the ECU 31, and rotates integrally with the shaft 65. The large diameter pulley 72 is formed to have a larger diameter than the small diameter pulley 71. The diameters of the pulleys 71 and 72 are set appropriately according to a required reduction ratio. The belt 73 is wound around the small diameter pulley 71 and the large diameter pulley 72.

When the motor 60 rotates, the motor torque is transmitted to the large diameter pulley 72 via the small diameter pulley 71 and the belt 73. The rotation of the large diameter pulley 72 is converted into linear motion of the rack shaft 97 by a rack and pinion mechanism.

The small diameter pulley 71 is housed in a gear housing 75. The large diameter pulley 72 and the rack shaft 97 are housed in a rack housing 76 in a cylindrical shape. In FIG. 2, the gear housing 75 and the rack housing 76 are integrally formed, but they may be formed separately. A sensor unit 10 is provided inside the gear housing 75 on a vertically lower side. A CAN wiring 44 connected to the sensor unit 10 is taken out from a hole formed in the gear housing 75 and connected to the connector 41.

As shown in FIGS. 3 and 4, the sensor unit 10 includes a first conductor 11, a second conductor 12, and a resistor 15. The first conductor 11, the second conductor 12 and the resistor 15 are provided on a sensor substrate 18. The sensor substrate 18 is attached to a lower wall portion in the vertical direction inside the gear housing 75 (not shown in the drawing).

The first conductor 11 is connected to a first terminal 311 of the ECU 31. The second conductor 12 is connected to a second terminal 312 of the ECU 31. The resistor 15 has one end connected to the first conductor 11 and the other end connected to the second conductor 12. The resistance value of the resistor 15 is appropriately set to a value that allows CAN communication. As a result, a CAN signal transmitted from the first terminal 311 passes through the first conductor 11, the resistor 15, and the second conductor 12 and is input to the second terminal 312.

The ECU 31 includes the control unit 35 and the CAN transceiver 36. The control unit 35 is mainly composed of a microcontroller or the like, and includes a CPU, a ROM, a RAM, an I/O, and bus lines connecting these components, all of which not illustrated. Each process in the control unit 35 may be a software process in which a program pre-stored in a physical memory device such as a ROM (i.e., a readable, non-transitory, tangible storage medium) is executed by the CPU, or may be a hardware process in which a dedicated electronic circuit is used.

As shown in FIG. 4, the control unit 35 includes, as functional blocks, a drive control unit 351, a water intrusion detection unit 352, a notification unit 353, and the like. The drive control unit 351 performs various processes related to the drive control of the motor 60.

The water intrusion detection unit 352 uses the CAN signal as a water intrusion detection signal to detect water intrusion into the sensor unit 10. When water intrusion is detected, the notification unit 353 notifies the driver of the water intrusion by, for example, turning on a warning light 48 provided on an instrument panel. Alternatively, the notification may be made by voice through a speaker 49.

The CAN transceiver 36 converts a bit signal from the control unit 35 into a CAN_H signal and a CAN_L signal, and outputs them to the sensor unit 10 via the first terminal 311. The CAN signal output from the CAN transceiver 36 to the sensor unit 10 passes through the first conductor 11, the resistor 15 and the second conductor 12 and is input to the second terminal 312. The CAN transceiver 36 converts the CAN signal input from the sensor unit 10 via the second terminal 312 into a bit signal and outputs it to the control unit 35. In FIG. 4, control lines, signal lines, and the like are partially omitted from the drawing for simplifying the drawing.

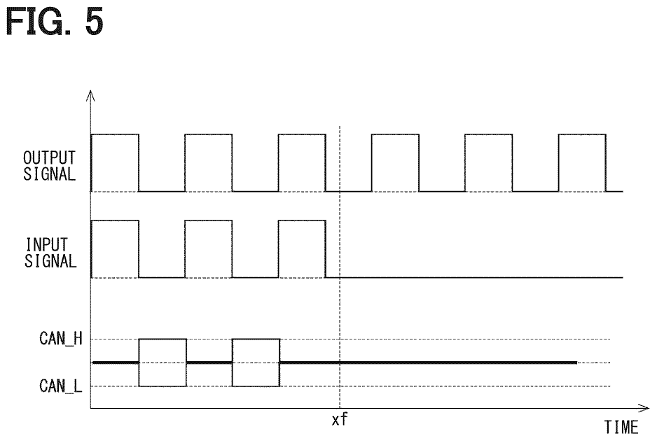

The details of the water intrusion detection will be explained with reference to the time chart of FIG. 5. In FIG. 5, the horizontal axis represents a common time axis, and from the top, the output signal from the control unit 35, the input signal to the control unit 35, and the CAN_H signal and the CAN_L signal, which are CAN signals, are shown.

The control unit 35 outputs a rectangular wave signal with a predetermined period. When the sensor unit 10 is not subject to water intrusion, the CAN_H signal and the CAN_L signal transmitted to and received from the CAN transceiver 36 are rectangular wave signals respectively corresponding to the output signal. Further, the input signal input from the CAN transceiver 36 becomes a rectangular wave signal corresponding to the output signal. When the input signal has a normal pattern corresponding to the output signal, the water intrusion detection unit 352 determines that the sensor unit 10 is not subject to water intrusion.

When the sensor unit 10 is subject to water intrusion at time xf, the first conductor 11 and the second conductor 12 are short-circuited, making it impossible to send and receive CAN signals, and the CAN_H signal and the CAN_L signal exhibit an abnormal pattern different from the normal pattern. FIG. 5 shows an example in which the CAN_H signal and the CAN_L signal are fixed at a predetermined value (for example, 2.5[V]), but depending on the condition of submerging in water, an abnormal pattern other than the pattern fixed at a predetermined value may occur. Further, the input signal input from the CAN transceiver 36 has an abnormal pattern different from that of the output signal. When the input signal has an abnormal pattern different from that of the output signal, the water intrusion detection unit 352 determines that the sensor unit 10 is subject to water intrusion.

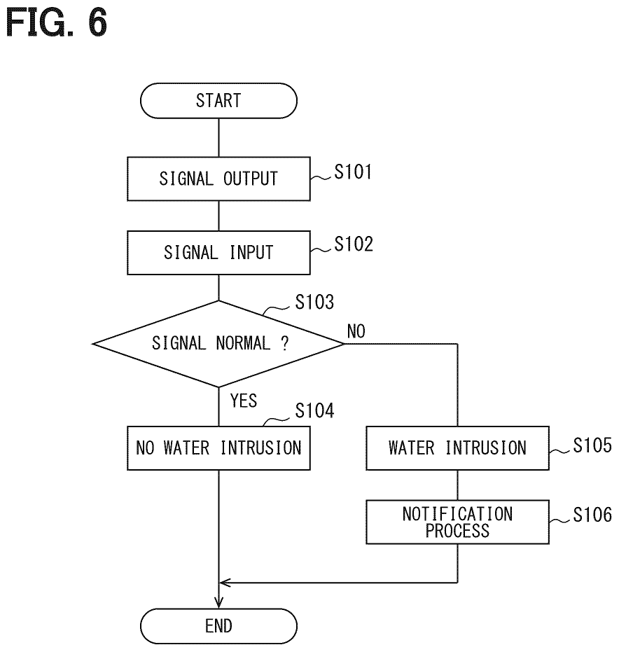

The water intrusion detection process of the present embodiment will be explained with reference to the flowchart of FIG. 6. This process is executed by the control unit 35 at predetermined intervals. Hereinafter, the “step” in step S101 will be omitted and the step will be written as “S.”

The control unit 35 outputs a water intrusion detection signal in S101, and receives the water intrusion detection signal in S102. In S103, the control unit 35 determines whether the received signal is normal. If it is determined that the received signal is normal (S103: YES), the process proceeds to S104, and the sensor unit 10 determines that the sensor unit 10 is not subject to water intrusion. If it is determined that the received signal is not normal (S103: NO), the process proceeds to S105, where it is determined that the sensor unit 10 is subject to water intrusion. In S106, the notification unit 353 notifies the driver that water intrusion has occurred.

In FIG. 6, for the sake of simplicity, the signal transmission and reception and water intrusion detection are explained as a series of processes, but for example, when the signal transmission and reception is performed at a relatively high speed, the signal transmission and reception period and the abnormality detection period may be different.

In the electric power steering device 8, there is a risk that water may enter into an inside of the gear housing 75, as indicated by an arrow W in FIG. 2. When the intruded water freezes, there is a risk that torque transmission from the motor 60 is hindered. Therefore, in the present embodiment, the sensor unit 10 is provided inside the gear housing 75, and water intrusion detection is performed by utilizing transmission and reception of CAN signals. By utilizing CAN communication, which is commonly used in vehicles, water intrusion is detectable with a relatively simple configuration without adding special logic for water intrusion detection.

As explained above, the detection device 1 includes the sensor unit 10, the CAN transceiver 36, and the control unit 35. The sensor unit 10 has the resistor 15 connected to the first conductor 11 and the second conductor 12 provided on the sensor substrate 18, and is provided in an area that may possibly be subject to water intrusion.

The CAN transceiver 36 outputs a water intrusion detection signal to the first conductor 11 and receives the water intrusion detection signal from the second conductor 12 via the resistor 15. The control unit 35 has the water intrusion detection unit 352 that detects water intrusion into the sensor unit 10 based on the water intrusion detection signal. The CAN transceiver 36 and the control unit 35 are provided at a position different from the sensor unit 10. In the present embodiment, they are provided in the ECU 31 which is a control unit. When receiving a water intrusion detection signal having a signal pattern that is different from a normal pattern, the water intrusion detection unit 352 determines that the sensor unit 10 is subject to water intrusion. In such manner, it is possible to detect water intrusion with a relatively simple configuration.

The detection device 1 is used in the steering system 90 for steering a vehicle. The sensor unit 10 is provided inside the gear housing 75 that houses the speed reduction mechanism 70 that connects (a) the steering transmission path from the steering wheel 91 to the road wheels 98 and (b) the motor 60. The control unit 35 has the drive control unit 351 that controls the drive of the motor 60. In such manner, water intrusion into the gear housing 75 is appropriately detectable. In particular, when the speed reduction mechanism 70 is attached to the rack shaft 97 close to the ground, it is more likely to be exposed to water than when it is mounted at a position relatively far from the ground, and therefore the detection device 1 is preferably used. Further, since the control unit 35 used to control the drive of the motor 60 performs the water intrusion detection, there is no need for a separate control component for detecting water intrusion.

In the present embodiment, the water intrusion detection signal is a CAN signal. When the water intrusion detection signal is a signal having constant value, the water intrusion detection unit 352 determines that the sensor unit 10 is subject to water intrusion. It should be noted that the constant value is one that allows fluctuations such as detection errors and noise. By using CAN signals that are commonly used in vehicles for detecting water intrusion, normal CAN communication control is applicable for detecting water intrusion, thereby requiring no separate logic for detecting water intrusion. Further, by utilizing an existing CAN circuit, the impact on noise performance is reducible.

### Second Embodiment

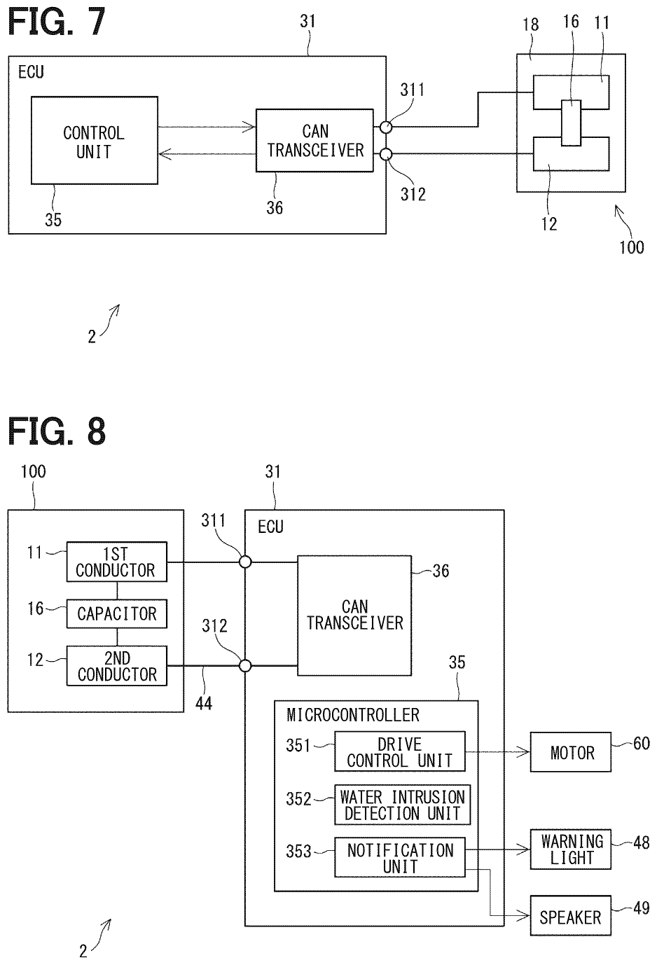

The second embodiment is shown in FIGS. 7 and 8. As shown in FIGS. 7 and 8, a detection device 2 includes a sensor unit 100, a CAN transceiver 36, and a control unit 35. The sensor unit 100 of the present embodiment is similar to the sensor unit 10 of the above-described embodiment, except that a capacitor 16 is provided instead of the resistor 15. The capacitor 16 is, for example, a surface-mount ceramic capacitor having a capacitance that allows CAN communication. The capacitor 16 has one electrode connected to a first conductor 11 and the other electrode connected to a second conductor 12.

Similar to the above-described embodiment, when the capacitor 16 is provided instead of the resistor 15, when the sensor unit 100 is subject to water intrusion, the first conductor 11 and the second conductor 12 are short-circuited, making it impossible to send and receive CAN signals. As a result, the CAN_H signal and the CAN_L signal exhibit an abnormal pattern that is different from normal, making it possible to detect water intrusion in the sensor unit 100. The details of the water intrusion detection are the same as those in the above-described embodiment.

In the present embodiment, the detection device 2 includes the sensor unit 100, the CAN transceiver 36, and the control unit 35. The sensor unit 100 includes the capacitor 16 connected to the first conductor 11 and the second conductor 12 provided on a sensor substrate 18, and is provided in an area that may possibly be subject to water intrusion.

The CAN transceiver 36 outputs the water intrusion detection signal to the first conductor 11 and receives the water intrusion detection signal from the second conductor 12 via the capacitor 16. The control unit 35 includes the water intrusion detection unit 352 that detects water intrusion in the sensor unit 100 based on the water intrusion detection signal. The CAN transceiver 36 and the control unit 35 are provided in a position different from the sensor unit 100, and the water intrusion detection unit 352 determines that the sensor unit 100 is subject to water intrusion when the received water intrusion detection signal has a signal pattern different from the normal pattern. The same effects as those of the above-described embodiments are obtainable even in the configuration explained above.

In the embodiment, the CAN transceiver 36 corresponds to a “communication circuit,” the speed reduction mechanism 70 corresponds to a “power transmission unit,” the gear housing 75 corresponds to a “housing,” and the steering wheel 91 corresponds to a “steering member.”

### Other Embodiments

In the above-described embodiments, a CAN signal is used as the water intrusion detection signal. In other embodiments, a signal other than a CAN signal may be used as long as the signal changes when the sensor unit is subject to water intrusion. When a signal other than a CAN signal is used as the water intrusion detection signal, a communication circuit that corresponds to the communication method can be used instead of the CAN transceiver.

In the above-described embodiment, the sensor substrate is provided on a bottom surface of the gear housing. In other embodiments, the sensor substrate may be provided at any position where water intrusion is possible and where detection of water intrusion is desired, for example, the sensor substrate may be attached to the vertically lower side of the gear housing. In other embodiments, circuit components other than resistors or capacitors, such as inductors, may be mounted on the sensor substrate. Further, the sensor substrate may have circuit patterns other than the first conductor and the second conductor formed thereon.

In the above-described embodiments, the detection device is applied to a steering system including an electric power steering device. In other embodiments, the steering system may be a steer-by-wire system or the like. Further, in other embodiments, the detection device may be applied to devices or systems other than the steering systems. Furthermore, the configuration of the drive device and the power transmission section may be different from that of the above-described embodiment.

The control unit and method thereof described in the present disclosure may be realized by a special purpose computer, which is configured with a memory and a processor programmed to execute one or more particular functions embodied in computer programs. Alternatively, the control unit and method thereof described in the present disclosure may be realized by a dedicated computer provided by constituting a processor with one or more dedicated hardware logic circuits. Alternatively, the control unit and method thereof described in the present disclosure may be realized by using one or more dedicated computers constituted by a combination of (a) the processor and the memory programmed to execute one or more functions and (b) the processor with one or more hardware logic circuits. Further, the computer programs may be stored, as instructions to be executed by a computer, in a non-transitory, tangible computer-readable storage medium. The present disclosure is not limited to the above-described embodiments, but various modifications may be made further within the scope of the present disclosure without departing from the spirit of the disclosure.

The present disclosure has been described in accordance with the embodiments. However, the present disclosure is not limited to such embodiments and configurations. The present disclosure also encompasses various modifications and variations within the scope of equivalents. Furthermore, various combination and formation, and other combination and formation including addition of one element, more than one or less than one element may be considered as being in the scope of the present disclosure.

What is claimed is:

1. A detection device comprising:
a sensor unit including a resistor or a capacitor connected to a first conductor and a second conductor that are provided on a sensor substrate, the sensor unit being provided in an area that is subject to water intrusion;
a communication circuit configured to output a water intrusion detection signal to the first conductor and to receive the water intrusion detection signal from the second conductor via the resistor or the capacitor; and
a control unit having a water intrusion detection unit configured to detect water intrusion of the sensor unit based on the water intrusion detection signal, wherein
the communication circuit and the control unit are provided at positions different from the sensor unit, and
the water intrusion detection unit is configured to determine that the sensor unit is subject to water intrusion when the water intrusion detection signal received at the communication circuit has a signal pattern that is different from a normal pattern.

2. The detection device according to claim 1, wherein
the detection device is used for a steering system for steering a vehicle,
the sensor unit is provided in a housing that houses a power transmission unit that connects a motor and a steering transmission component extending from a steering member to road wheels, and
the control unit has a drive control unit that controls a drive of the motor.

3. The detection device according to claim 1, wherein
the water intrusion detection signal is a CAN signal, and
the water intrusion detection unit determines that the sensor unit is subject to water intrusion when the water intrusion detection signal is a signal having a constant value.

4. A detection device comprising:
a sensor unit including a resistor or a capacitor connected to a first conductor and a second conductor that are provided on a sensor substrate, the sensor unit being provided in an area that is subject to water intrusion;
a communication circuit configured to output a water intrusion detection signal to the first conductor and to receive the water intrusion detection signal from the second conductor via the resistor or the capacitor; and
a controller including at least one of a circuit and a processor having a memory storing computer program code, wherein
the communication circuit and the controller are provided at positions different from the sensor unit, and
the controller is configured to determine whether the water intrusion detection signal received at the communication circuit has a signal pattern different from a normal pattern, and to determine that the sensor unit is subject to water intrusion when the water intrusion detection signal received at the communication circuit has a signal pattern that is different from the normal pattern.

5. The detection device according to claim 4, wherein
the water intrusion detection signal is a CAN signal, and
the controller determines that the sensor unit is subject to water intrusion when the water intrusion detection signal received at the communication circuit is a signal having a constant value.
